(19) United States
(12) Patent Application Publication
(10) Pub. No.: US 2005/0097839 A1
(43) Pub. Date: May 12, 2005

(54) Door frame

(75) Inventor: Lawrence Frank Kerscher, De Pere, WI (US)

Correspondence Address: WILHELM LAW SERVICE, S.C., 100 W LAWRENCE ST, THIRD FLOOR, APPLETON, WI, 54911, US

(73) Assignee: Bay Industries, Inc, Green Bay, WI (US)

(21) Appl. No.: 11/015,237

(22) Filed: Dec. 17, 2004

Related U.S. Application Data
(63) Continuation-in-part of application No. 10/109,759, filed on Mar. 28, 2002.
(60) Provisional application No. 60/355,592, filed on Feb. 7, 2002.

(51) Int. Cl. E06B 1/04

(52) U.S. Cl. 52/204.1

(57) ABSTRACT

A door frame which employs jambs or jamb assemblies which are essentially devoid of wood and other materials which are susceptible to being damaged by the affects of weather. The side jambs are fabricated of e.g. extruded aluminum moldings which extend an underlying floor/substrate to the header, and can be fabricated from a common-profile extruded aluminum molding. The jambs can also have an e.g. polymeric insert assembled thereto which can receive nails or screws, optionally without pre-drilling, in a similar manner as wood receives nails or screws. The jambs can further include a nosing either integral with, or snap assemblable thereto. The molding can further include a nail fin kerf which accepts a rigid or a flexible nailing fin.

### CROSS-REFERENCE TO RELATED APPLICATIONS

This application is a Continuation-in-Part of application Ser. No. 10/109,759, filed 03/28/2002, which is herein incorporated by reference in its entirety. Application Ser. No. 10/109,759 is the non-provisional of application Ser. No. 60/355,592. Accordingly, this application claims priority under 35 U.S.C. 120 to application Ser. No. 10/109,759 and to application Ser. No. 60/355,592.

### BACKGROUND

This invention pertains to prefabricated and otherwise assembled aluminum door frames.

When installing a door frame into a door opening in a building, it is desirable to have a strong, durable, rot and decay resistant, frame which is either prefabricated or easily assembled on the construction site. Preferably, the frame can be assembled at an off-site manufacturing location. In the alternative, it is desirable to have frame elements which are easily assembled at the construction site.

In a typical construction project involving doors, door frames are fabricated by a frame fabricator, and are thence shipped to a door assembler. The door assembler receives the frames as fabricated, and assembles e.g. the frames to respective door slabs. The slabs are also commonly purchased separately from slab manufacturers. The door assembler adds the desired glass inset, if any, to the door slab, assembles the door slab to a selected door frame, and ships the thus assembled door, including frame and slab, to the construction site for installation on the building.

In the known art, the basic frame of the door is commonly wood. The door assembler can up-grade the quality and value of the frame, and thus the quality and value of the door assembly, to some extent, by installing e.g. aluminum cladding to the left, right, and top frame wood substrate members, thus to provide maintenance free, tough, and durable exterior surfaces to the frame.

However, even where the jamb substrate is up-graded with aluminum cladding, the properties of the wood substrate still have substantial affect on the use life, and ongoing properties of the door frame. Such wood substrate can be subject to attack by rot, insects, and other invasive organisms which cause the properties of the wood to deteriorate.

For example, the bottom of the wood frame commonly is supported directly by an underlying surface such as concrete, dirt, or the like. Where the door frame is mounted as an exterior entrance to a building, the outwardly-disposed side of the door frame is subjected the weather, including rain, snow, changes in temperature, changes in humidity, and the like. Such environmental conditions are detrimental to the long-term stability of the wood substrate. As a first example, the wood readily absorbs and holds water. So any rain can be a source of moisture which is absorbed by that portion of the wood which interfaces with the underlying ground or concrete.

The moisture, as absorbed, can be wicked upwardly into a few inches of the wood. While present in the wood, the moisture supports bacteria or other life forms which feed on the substances of the wood, causing loss of strength in the wood. Over a period of time, and with repeated such exposures to water, the wood eventually decays to a form commonly known as rotten wood. Rotten wood does not have the structural qualities of wood which has not been so decayed, whereby the resulting door frame does not provide the desired degree of support for the door, and the frame fails.

Wood is also subject to attack by insects, which also causes structural deterioration of the wood, and thus deterioration of support for the door.

Certainly, the door frame can be replaced or repaired. However, it would be preferable to avoid the deterioration which accompanies wood structures at the doorway.

Thus, it is an object of the invention to provide door jambs and door frames which are not subject to deleterious affects such as those which are visited on wood by weather and/or insects.

It is another object to provide door jambs and door frames which are made with materials all of which withstand weather and insects for substantially longer periods of time than wood which is subjected to the same conditions.

### SUMMARY

This invention provides a door frame which employs jambs or jamb assemblies which are essentially devoid of wood and other materials which are susceptible to being damaged by the affects of weather, in those areas of the frame which will be subjected to substantial affects of weather. Thus, the side jambs are fabricated of e.g. extruded aluminum moldings which extend from e.g. the floor, concrete, or other underlying substrate, to the header, which can be fabricated from a common-profile extruded aluminum molding. A nosing can be provided with the aluminum molding, either integral with the aluminum molding or snap assemblable to the aluminum molding. The molding can include a nail fin kerf at or adjacent an outer panel of the jamb, or on the nosing, whereby the door frame can include a nailing fin. Such nailing fin can be a rigid e.g. aluminum molding nailing fin, or can be a flexible e.g. polymeric nailing fin. An e.g. polymeric insert can be provided, assembled to the aluminum molding, which can receive nails or screws, optionally without pre-drilling, much in the same manner as wood receives nails or screws. Nails and/or screws can thus be driven through the insert and into adjacent framing members of the building, thus to mount the door, door frame to the building.

In a first family of embodiments, the invention comprehends a door jamb, having a length, and being adapted to be received into a rough opening in a building, the door jamb comprising an aluminum molding, the aluminum molding comprising (a) an aluminum jamb element having a length, and comprising (i) a first side panel facing toward such rough opening, (ii) a second side panel facing away from such rough opening, (iii) an outer panel facing outwardly of such building, and (iv) an inner panel facing inwardly into such building; and (b) an aluminum nosing element, integral with the aluminum jamb element and extending outwardly of such building from the outer panel of the jamb element, along a substantial portion of the length of the aluminum jamb element.

In some embodiments, the nosing having a first side facing toward such rough opening, the first side of the nosing being located away from such rough opening relative to the first side panel of the jamb element.

In some embodiments, the doorjamb further comprising at least one of (1) a nailing fin kerf, (2) a casing-receiving recess extending along the length of the door jamb, and (3) a cavity in the aluminum jamb element adapted to receive a durable nail-receptive and/or screw-receptive insert along at least a substantial portion of the length of the jamb element.

In some embodiments, the aluminum molding comprising a cavity adapted to receive an insert thereinto, and further comprising an insert in the cavity, the insert being defined by a durable, rot and decay resistant, material.

In some embodiments, the insert extends along a substantial portion of the length of the aluminum molding.

In some embodiments, the insert extends along substantially the full length of the aluminum molding.

In some embodiments, the insert is made from a material which is receptive to nails and/or screws, as fasteners fastening the insert to a building.

In some embodiments, a portion of the insert abuts against an edge or surface of the aluminum molding.

In some embodiments, the aluminum molding extends along substantially the full length of the door jamb.

In some embodiments the nosing comprising a mounting fin kerf.

In some embodiments, the door jamb further comprising a mounting fin in the mounting fin kerf.

In some embodiments, the aluminum molding defining a casing-receiving recess extending along the length thereof, further comprising a casing received in the recess.

In some embodiments, the casing comprising one of (i) a brick mold casing and (ii) a flat casing.

In some embodiments, the casing comprising a flat casing, an outer surface of the casing, which faces outwardly away from such building, being substantially co-planar with an outer surface of the nosing.

In some embodiments, the nosing defining a closed cross-section of the nosing.

In some embodiments, the aluminum jamb element defining a closed cross-section of the jamb element.

In some embodiments, the aluminum jamb element comprising longitudinally spaced mounting holes in the first and second side panels, the mounting holes in the first and second side panels being registered with each other so as to enable fasteners to pass through both of the first and second side panels along straight line paths.

In some embodiments, the insert is made of hydrophobic material which does not readily absorb a substantial quantity of water, and wherein the hydrophobic material is selected from the group consisting of (i) polymeric resin, and (ii) polymeric resin in combination with filler material which is compatible with the polymeric resin, wherein the polymeric resin is sufficiently continuous in the combination to prevent substantial absorption of water into the combination.

In some embodiments, the filler material is selected from the group consisting of wood particles, other cellulosic material, fibrous material, other organic and/or inorganic fillers, and combinations thereof.

In some embodiments, the aluminum jamb element further having a rear defining a closed cross-section of the jamb element, the insert extending, along the length of the jamb element, rearwardly of the rear, whereby the insert can be fastened to such building by driving fasteners through the insert at locations disposed rearwardly of the rear of the jamb element.

In a second family of embodiments, the invention comprehends a door jamb adapted to be received into a rough opening in a building, the door jamb having a length, a rough opening side, and an opposing side, and comprising: (a) an aluminum molding, the aluminum molding defining an aluminum jamb element having a length, and comprising (i) a first side panel facing toward such rough opening, (ii) a second side panel facing away from such rough opening, (iii) an outer panel facing outwardly of such building, (iv) a rear opposing the outer panel, and (v) a cavity extending along the length of the aluminum jamb element, the cavity being adapted to receive an insert thereinto; and (b) an insert in the cavity, the insert extending along the length of the aluminum jamb element, the insert having a front disposed toward the outer panel and a back disposed relatively toward the rear, the insert being defined by a durable, rot and decay resistant, material which is receptive to nails and/or screws, as fasteners adapted to fasten the insert to such building, the combination of the aluminum jamb element and the insert providing straight-line paths from the rough opening side of the door jamb to the opposing side of the door jamb, by which nails and/or screws can be driven through the insert without having to create new holes in either the first side panel or the second side panel of the aluminum jamb element, the straight-line paths being located between the back of the insert and a mid-point between the outer panel and the rear of the aluminum molding.

In some embodiments, the cavity extends along the length of the aluminum jamb element, and wherein the cavity is defined by first and second cavity side panels defined inwardly of the rough opening side of the door jamb and the opposing side of the door jamb, and wherein the cavity is further defined by a front cavity panel disposed between the outer panel and the rear of the aluminum jamb element, an elongate opening extending along a substantial portion of the length of the aluminum jamb element and into the cavity, between the first and second side panels at the rear of the aluminum jamb element.

In some embodiments, the straight-line paths are defined between the rear and the outer panel, and further comprising fastener holes spaced longitudinally along the aluminum jamb element and through the first and second side panels.

In some embodiments, the door jamb further comprising locking structure on the aluminum jamb element, extending outwardly of such building from the outer panel and, as a separate element, a nosing mounted to the aluminum jamb element at the outer panel by the locking structure.

In some embodiments, the aluminum jamb element extends along a substantial portion of the length of the doorjamb.

In some embodiments, the aluminum jamb element extends along substantially all of the length of the door jamb.

In some embodiments, the door jamb further comprising a nosing extending outwardly from the outer panel and away from such building.

In some embodiments, the nosing and the jamb element being defined in a common unitary body.

In some embodiments, the nosing comprising a mounting fin receptacle.

In some embodiments, the doorjamb further comprising a mounting fin in the mounting fin receptacle.

In a third family of embodiments, the invention comprehends a door frame adapted to be mounted in a rough opening in a building, the door frame comprising first and second side jamb assemblies, and a header jamb assembly extending between the first and second side jamb assemblies, at least one side jamb assembly having an upper member and a lower member, the upper member having a length, and defining at least one cavity extending along the length thereof, the lower member defining an insert portion received into the cavity and an extension portion extending downwardly from the lower edge of the upper member a distance sufficient to substantially avoid travel of liquid water, by surface tension, from a lower edge of the lower member to a lower edge of the upper member, the extension portion being defined by a durable rot and decay resistant material.

In a fourth family of embodiments, the invention comprehends a door frame adapted to be mounted in a rough opening in a building, the door frame comprising: (a) first and second side jamb assemblies, at least one of the side jamb assemblies comprising an aluminum jamb element having a length, and comprising (i) a first side panel facing toward such rough opening, (ii) a second side panel facing away from such rough opening, (iii) an outer panel facing outwardly of such building, and (iv) an inner panel facing inwardly into such building at or proximate a rear of the aluminum jamb element, the aluminum jamb element extending substantially the entirety of the length of the jamb assembly such that the at least one side jamb assembly is supported, by the aluminum extrusion, from an underlying support, within a distance of such underlying support to enable travel of liquid water, by surface tension, from a lower edge of the side jamb assembly to the aluminum jamb element; and (b) a header extending between the first and second side jamb assemblies.

### BRIEF DESCRIPTION OF THE DRAWINGS

FIG. 1 shows a pictorial view of a first embodiment of door frames of the invention, with parts cut away, as a garage door, with the garage door partially lifted.

FIG. 2 shows a cross-section of a first embodiment of door jambs, including integral nosing structure, used in door frames of the invention.

FIG. 3 shows a cross-section of a brick mold casing which can be mounted to the jamb of FIG. 2.

FIG. 4 shows a cross-section of an assembly of the jamb of FIG. 2 and the brick mold casing of FIG. 3.

FIG. 5 shows a cross-section of a flat add-on casing which can be mounted to the jamb of FIG. 2.

FIG. 6 shows a cross-section of an assembly of the casing of FIG. 5, the jamb of FIG. 2, including a durable mounting member insert received in an open-edged cavity of the jamb.

FIG. 7 shows an enlarged cross-section of the jamb assembly of FIG. 1, and is taken at 7-7 of FIG. 1.

FIG. 8 shows an end view of an “L-shaped” spring clip which can be used at mitered corners of jamb elements used in door frames of the invention.

FIG. 9 shows a bottom view of the spring clip of FIG. 8.

FIG. 10 shows an edge view of a corner gusset which is employed in the jamb elements at right-angle corners of a door frame of the invention.

FIG. 11 shows an enlarged front elevation view of an upper corner of a garage door frame of the invention, with parts cut away, incorporating the corner gusset of FIG. 10, and is taken at dashed circle 11 in FIG. 1.

FIG. 12 shows a rear view of the upper corner of the door frame of FIG. 11, as seen from inside the building.

FIG. 13 shows an edge view of a corner gusset which is employed in jamb elements at gusseted corners of a door frame of the invention.

FIG. 14 shows an enlarged front elevation view of an upper corner as in FIG. 11 and wherein the corner structure includes use of an angled gusset.

FIG. 15 shows a cross-section of a second embodiment of door jamb assemblies of the invention, showing a second embodiment of the jamb, including a durable, non-wood mounting member insert received in a cavity of the jamb.

FIG. 16 shows a cross-section of a third embodiment of door jamb assemblies of the invention, showing a third embodiment of the jamb, including a durable non-wood mounting member insert received in a cavity of the jamb.

FIG. 17 shows a cross-section of a fourth embodiment of door jamb assemblies of the invention, showing a fourth embodiment of the jamb, including a durable non-wood mounting member insert received in a cavity of the jamb.

FIG. 18 shows a cross-section of a further embodiment of door jambs of the invention, wherein the durable, member-holding cavity has been deleted; and wherein registered mounting holes have been added along the length of the jamb, to opposing faces of the jamb.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

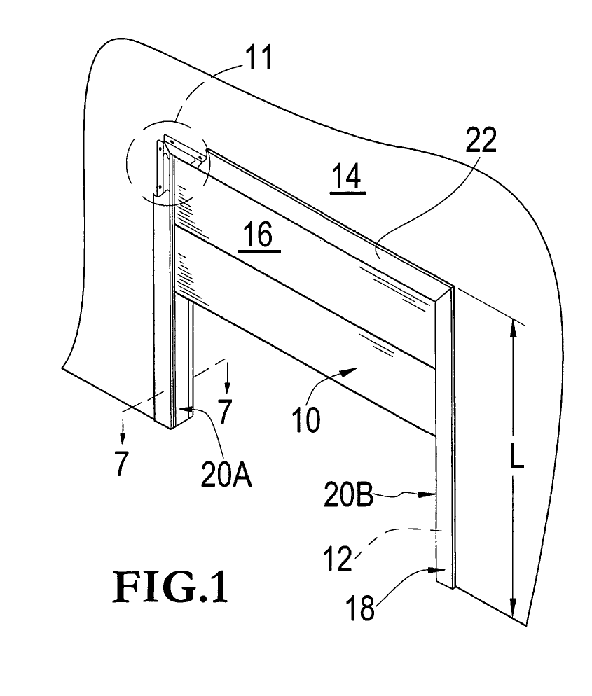

Turning now to the drawings, FIG. 1 shows a garage door 10 mounted in a rough opening 12 in a building 14. As illustrated, the garage door is partially open, such that only two of the commonly-used four garage door panels 16 are visible.

FIG. 1 shows, in general, a door frame 18, which includes left 20A and right 20B side jamb assemblies generally designated 20, and a header assembly 22 extending across the top of the rough opening and connected to the two side jamb assemblies. The side jamb assemblies and the header assembly have generally common cross-sections, whereby the description of one of the side jamb assemblies is effective to describe the header and the other side jamb assembly. The rough opening, and correspondingly the finished opening, is sized, adapted, and configured to cooperate with a door to be used in conjunction with the frame. Thus, when the frame is used in entry door applications, the distance between the side jamb assemblies has a magnitude of at least about 2 feet 8 inches, and others. Alternatively, when the frame is used in garage door applications, the distance between the side jamb assemblies has a magnitude of at least about 3 feet, at least about 4 feet, at least about 7 feet, at least about 10 feet, and others.

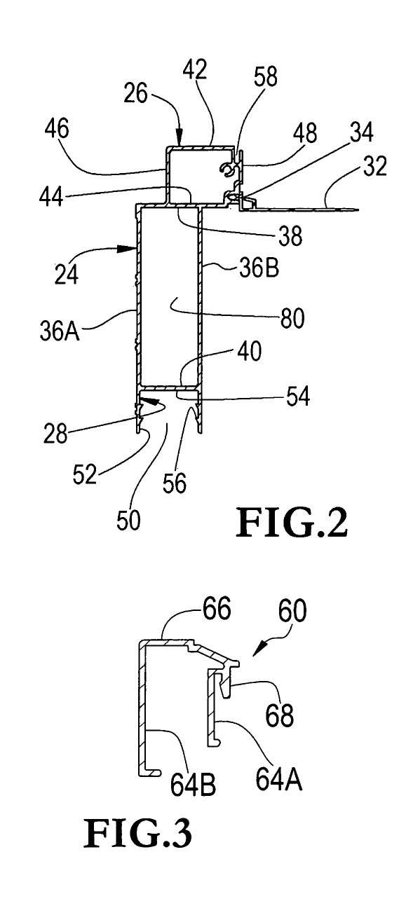

FIG. 2 shows an aluminum extrusion/molding in the form of a jamb element, e.g. jamb 24, having a nosing element illustrated as integral nosing 26 whereby the jamb element and the nosing together, at least partially, define a generally common unitary body. As used herein, the terms extrusion, molding, extruded, and molded, refer to numerous forming methodologies and end-production, which include, but are not limited to, extrusions, castings, moldings, forgings, stampings, and/or others.

Jamb 24 further includes a cavity 28 adapted to receive an insert 30. A nailing fin 32 is shown mounted in a nailing fin receptacle, namely fin kerf 34, in the nosing. Jamb 24 is generally defined by left 36A and right 36B side panels, outer panel 38, and inner panel 40. In the assembled, installed, jamb 24, the left side panel 36A faces into the doorway opening and right side 36B faces the building framing members which define the rough opening. Outer panel 38 faces outwardly of the building and inner panel 40 faces inwardly toward the inside of the building.

Nosing 26 is defined by outer wall 42, inner wall 44, and sides 46, 48. In the embodiment of FIG. 2, the inner wall of the nosing and the outer panel of the jamb are each defined in part by a common strip of metal. Side 46 faces into the doorway opening and is located away from the rough opening relative to jamb element left side panel 36A.

Cavity 28 defines an elongate opening 50 open to the rear of the extrusion/molding and extending along a substantial portion of the length of the jamb, optionally along substantially the full length of the jamb, optionally along the entirety of the length of the jamb. Cavity 28 is in general defined by left and right side walls 52, which are extensions of side panels 36A and 36B, by front wall 54 which corresponds to inner panel 40 of the jamb, as well as by opening 50. Thus, left and right side walls 52 at least partially define a rearmost portion, e.g. rear of the aluminum extrusion/molding jamb element, at or adjacent, for example their terminal ends which are distal the remaining components of jamb 24.

Protuberances 56, project into the cavity from side walls 52. Protuberances 56 are designed with abutting surfaces which face toward nosing 26 and which are designed to interface with corresponding rearwardly-facing surfaces of insert 30, which can be parts of channels, grooves, chamfers, bevels, or other inward projections and/or other structure, formed into or extending from (as will be explained in greater detail elsewhere herein), insert 30 which mechanically corresponds to protuberances 56 thereby to impede withdrawal of the insert from the cavity toward the rear of the jamb, namely toward the interior of the building.

An elongate recess 58, e.g. a casing-receiving recess, extends along the length of the nosing, proximate the outer surface of the nosing, and is adapted to receive thereinto, and hold, an elongate casing such as a brick mold 60 or a generally flat casing, e.g. extended-width casing 62. FIG. 3 illustrates a brick mold casing 60. Casing 60 includes left and right side walls 64A, 64B and an outer wall 66. An elongate mounting stub 68 extends parallel to, and offset from, side wall 64A and extending away from outer wall 66. Stub 68 is sized and configured to fit into, and to generally fill, recess 58, thereby to mount the casing to the nosing by friction engagement between the nosing and the casing.

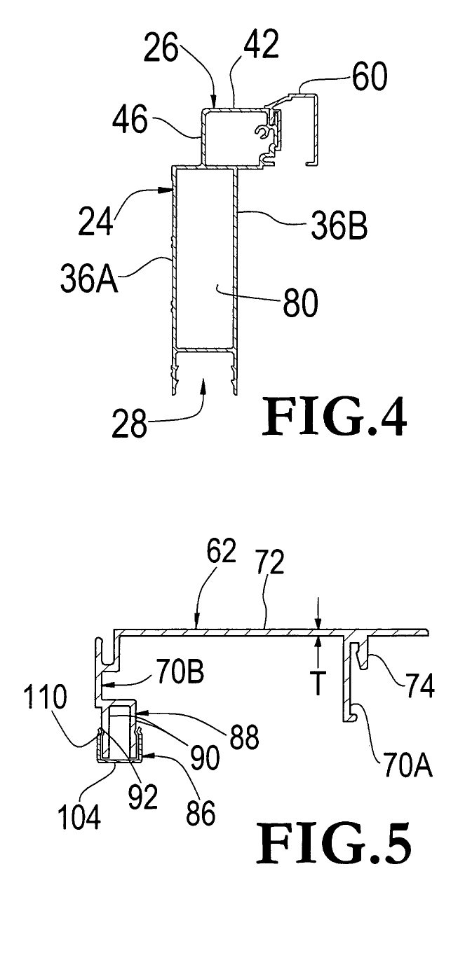

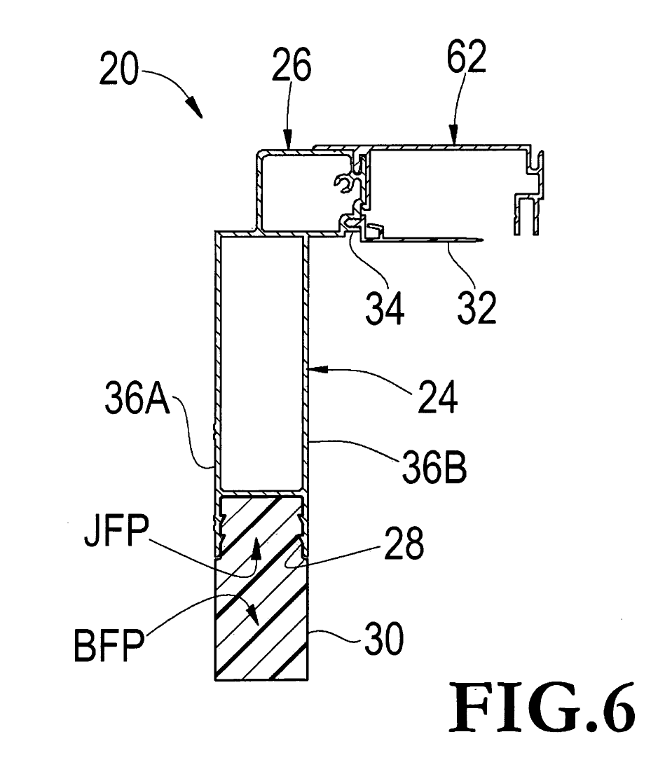

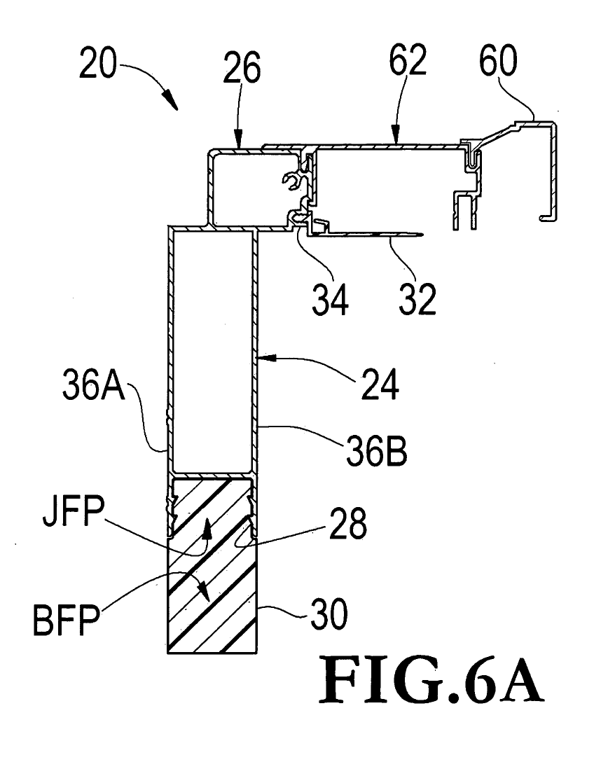

FIG. 5 shows extended-width flat casing 62. Casing 62 includes left and right side walls 70A, 70B, and an outer wall 72. Stub 74 is sized and configured to fit into, and to generally fill, recess 58, thereby to mount casing 62 to the nosing by friction engagement between the nosing and the casing. In the assemblage of casing 62 and jamb 24, the outer, flat, surface of casing 62 is substantially co-planar with an outer surface of the nosing of jamb assembly 20. As can be seen by comparing FIGS. 4 and 6, in general, casing 60 or casing 62, but not both, may be mounted to a given recess 58.

Referring now to FIGS. 1, 6, and 7, a given side jamb assembly 20 typically includes an extruded/molded aluminum jamb 24, and can include a nosing 26 integral with the jamb or, as discussed hereinafter, attached to the jamb as a separate element. A casing 60, 62, or both, can be, as illustrated in FIGS. 4, 6, and 6A, mounted to the jamb, either directly or through the nosing. A nailing fin 32 can be mounted directly to the frame or frame elements, including to the jamb, or to the nosing, or to the casing.

A durable, rot and decay resistant, and insect resistant, insert 30 can be mounted in the jamb to serve as a stiffening member, and/or to serve as an attachment structure, whereby the jamb assembly can be nailed or screwed to one or more building framing members. Insert 30 has a jamb facing portion “JFP” and a building facing portion “BFP”. Jamb facing portion “JFP” of insert 30 generally faces and communicates with jamb 24, and building facing portion “BFP” of insert 30 generally faces “into” the building (in the installed product). As exemplarily illustrated, a terminal end surface of jamb facing portion “JFP” interfaces with, abuts, and/or otherwise communicates with, an edge or surface of the aluminum extrusion/molding, e.g. cavity front wall 54 or other edges and/or surfaces of jamb 24.

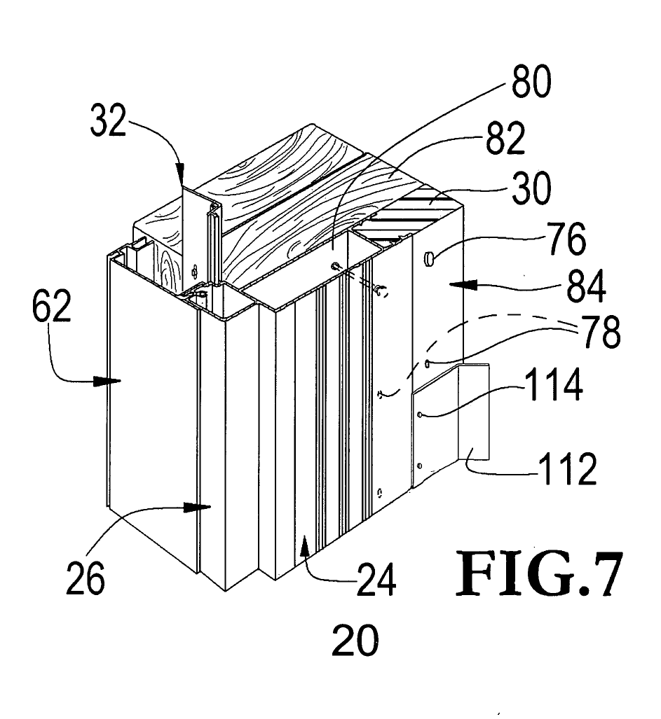

In the exemplary embodiment illustrated in FIGS. 6 and 7, at least part of insert 30's jamb facing portion “JFP” has a width dimension which is of lesser magnitude than the width dimension of the building facing portion “BFP”. Preferably, the difference in the magnitudes of the jamb facing portion “JFP” and building facing portion “BFP” widths corresponds to the magnitude of the sum of the thickness dimensions of left and right cavity sidewalls 52 which generally extend from side panels 36A, 36B, respectively.

Thus, when insert 30 is housed in cavity 28, the outer surface of left side panel 36A and the portion of the outer surface of the left side of insert 30 which extends beyond the cavity side wall 52 generally collectively define a generally planar surface e.g. with no substantial step-change in surface profile height along at least a major portion of the collective surface thereof. Likewise, when insert 30 is housed in cavity 28, the outer surface of right side panel 36B and the portion of the outer surface of the right side of insert 30 which extends beyond the cavity side wall 52 generally collectively define a generally planar surface e.g. with no substantial step-change in surface profile height along at least a major portion of the collective surface thereof.

Also as exemplarily illustrated, the jamb facing portion “JFP” has at least one interfacing structure which is adapted and configured to interface with the protuberances of the cavity sidewalls 52. In the illustrated embodiments, each of the interfacing structures is a “V-type” groove, which has first and 'second terminally intersecting groove walls. One of the groove walls extends generally perpendicularly into insert 30 and the other of the groove walls extends angularly into insert 30. Other interfacing structures are contemplated and are well within the scope of the invention, including, but not limited to, channels, grooves, chamfers, bevels, or other inward projections and/or other structure, formed into or extending from, insert 30.

Insert 30 can be disposed in a location generally toward the interior of the building such as inwardly of front wall 54 of the cavity, and generally to the rear of jamb 24. In such instance, and as illustrated in FIG. 7, nails 76 or screws (not shown) can be driven through the insert much like nails and screws are commonly driven through wood structural members, since the insert extends along the length of the jamb element, and e.g. rearwardly of a rear portion of the jamb element and since insert 30 can accept fasteners and/or hardware therethrough.

Depending on the material composition of insert 30, and the structure of the respective nails or screws, mounting holes 78 may or may not be pre-drilled or punched, as round or slotted holes in insert 30. Where a softer material such as polyethylene, nylon or the like is used, pre-drilled holes are generally not required. Where a harder material such as polycarbonate or an acrylic is used in fabricating insert, pre-drilled holes may be desirable.

Regarding materials from which insert 30 can be fabricated, there can be mentioned for example and without limitation, various of the polyethylenes, polyamides such as nylon, vinyl, acrylic, polycarbonate, or the like. Typically, a generally hydrophobic thermoplastic material is selected as the base material for use in insert 30. As additional compositional ingredients, there can be mentioned a wide array of additives and fillers which can be used to enhance the properties of the resultant insert, and/or to reduce the cost of the insert. In general, any additive such as a filler must be compatible with the polymeric resin, and the proportion of the ingredients must be such that the polymeric resin is sufficiently continuous in the combination to prevent substantial absorption of water into the finished combination. Suitable fillers include, but are not limited to, wood particles, other cellulosic material, fibrous material, other organic and/or inorganic fillers, combinations thereof, and others.

Thus, in general, the polymeric resin is a continuous phase in the combination, and any hygroscopic filler or other inclusions are discontinuous inclusions in the continuous resin phase. A modest level of foaming, namely voids, is acceptable in insert 30 so long as the hydrophobic properties of the insert are preserved.

In some embodiments, the insert, or a portion of the insert, or a second insert, can be disposed frontwardly of the inner panel 40 of the jamb, which corresponds to the front wall 54 of the cavity, thus between inner panel 40 and outer panel 38. Thus, the rib which extends between the left 36A and right 36B side panels of the jamb serves both as the inner wall of the jamb 24 and as the front wall of cavity 28. Where the insert is disposed frontwardly of the inner panel of the jamb, the insert is desirably, but not necessarily, disposed proximate the inner panel. In such instance, and contrary to the illustration of FIG. 7, insert 30 is located inside the tubular cavity 80 defined between side panels 36A, 36B, outer panel 38, and inner panel 40.

Mounting holes 78, shown in dashed outline in FIG. 7, are pre-drilled through aluminum side panels 36A, 36B of jamb 24 as well as through insert 30 (illustrated in solid outline), all longitudinally spaced from, and in registration with, each other, whereupon nails or screws can be driven through insert 30, alternatively through side panels 36A, 36B, generally along a straight line path, and into the respective framing members 82 of the building which define the rough opening in the building.

In the embodiments illustrated in FIGS. 1, 2, 6, and 7, insert 30 generally fills cavity 28 between left and right walls 52, and extends to the rear of the cavity, to the rear of the jamb, by a sufficient distance to provide a substantial nailing surface 84 for driving nails or screws through and into framing members 82 of the building well ahead (outwardly of the building) of the inward edges of the framing members.

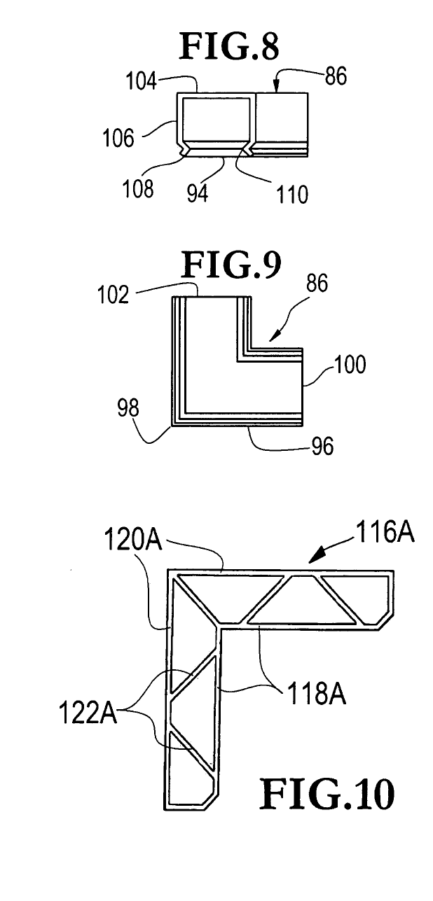

FIG. 5 shows a cross-section of extended-width casing 62 which, as discussed above, can be received in the elongate recess in nosing 26. A spring clip 86, illustrated in more detail in FIGS. 8 and 9, is shown assembled to the casing in FIG. 5. The assembly of the extended-width casing to the nosing is illustrated in FIG. 6. Assembly of spring clip 86 to the casing is illustrated in FIG. 5. As illustrated there, outer side wall 70B of casing 62 includes an elongate mounting fork 88 having a pair of elongate tines 90 extending along the length of the casing. Each tine has an elongate channel 92 extending along the length of the casing, along the length of the tine, and spaced from a distal edge of the respective tine.

Referring still to FIGS. 5, 8, and 9, spring clip 86 generally defines an “L-shaped” channel 94 having first and second legs 96 which meet at a corner 98. FIG. 8 shows a view from the end of one of the legs of the spring clip. FIG. 9 shows a view from the open-channel side of the spring clip. Referring specifically to FIG. 9, in general, channel 94 extends at a constant cross-section from a first end 100 at one of the legs through corner 98 to a second end 102 at the other of the legs. As viewed in FIG. 8, channel 94 has a top wall 104, and two downwardly-depending side walls 106 which terminate at distal ends 108. Each side wall 106 has an inwardly-projecting ridge 110 which constricts the width of the channel proximate the distal ends of the legs, namely near the open bottom of the channel.

Referring, now to FIG. 5, the ridges 110 in the side walls of the spring clip are resiliently received in channels 92 of tines 90 whereby the ridges and channels cooperate in holding the spring clip mounted on the casing. FIG. 12 shows the corner structure of the frame as viewed from inside the building, looking outwardly of the building through the doorway which is being framed by frame 18. FIG. 12 shows that the spring clip bridges the corner 111 of frame 18, which is defined between one of the side jamb assemblies and the header jamb assembly.

In the assemblage of jamb assembly 20 and header assembly 22, first and second miter joints are defined at the intersection of jamb assembly 20A and header assembly 22, and at the intersection of jamb assembly 20B and header assembly 22. The mitered portion of jamb assembly 20 and the mitered portion of header assembly 22 interface with each other and are snugly held in such interfacing relationship by ones of spring clips 86. Accordingly, spring clips 86 control movement of respective ends of header jamb assembly 22 and the corresponding side jamb assembly 20 with respect to each other, in a direction toward and/or away from such building, and/or in a direction generally toward and/or away from the rough opening which extends through the building.

Stated another way, the first and second legs of the spring clip resiliently grip the outwardly disposed edges of the respective mitered ends of the extended casing 62 at the corner defined by a side jamb assembly and the header jamb assembly. Since ridges 110 are at a common distance from top wall 104 on both legs, since channels 92 are located a common distance from outer wall 72 of the casing, the ridges gripping the tines at channels 92 positively seat the respective casings on the header jamb and the side jamb relative to each other such that the outside surfaces of the respective casings are located in a common plane which extends generally parallel to the outer surface of the building. Stated another way, the spring clip holds the two mitered ends of the casing flush with each other, at a common distance from the outer surface of the building.

Referring to FIG. 6, polymeric, flexible, nailing fin 32 is shown in nailing fin kerf 34 in the nosing, under the extended-width casing. Accordingly, the nailing fin is commonly nailed, or otherwise mounted, to the building framing before the extended casing is installed in recess 58 of the nosing.

As indicated earlier, FIG. 7 illustrates the jamb assembly of FIG. 6 mounted to a double stud structure, exemplarily illustrated as the two adjacent framing members 82, of the building frame using nails 76, either through insert 30 as shown, or as indicated in dashed outline, through pre-drilled holes in side panels 36A, 36B of the jamb. FIG. 7 further illustrates weather stripping 112 mounted to the insert by e.g. nails 114, and adapted to interface with a garage door mounted in the frame opening. Nails 114 can be inserted through pre-punched or pre-drilled, round or slotted holes, or can be driven through material which has no pre-formed holes.

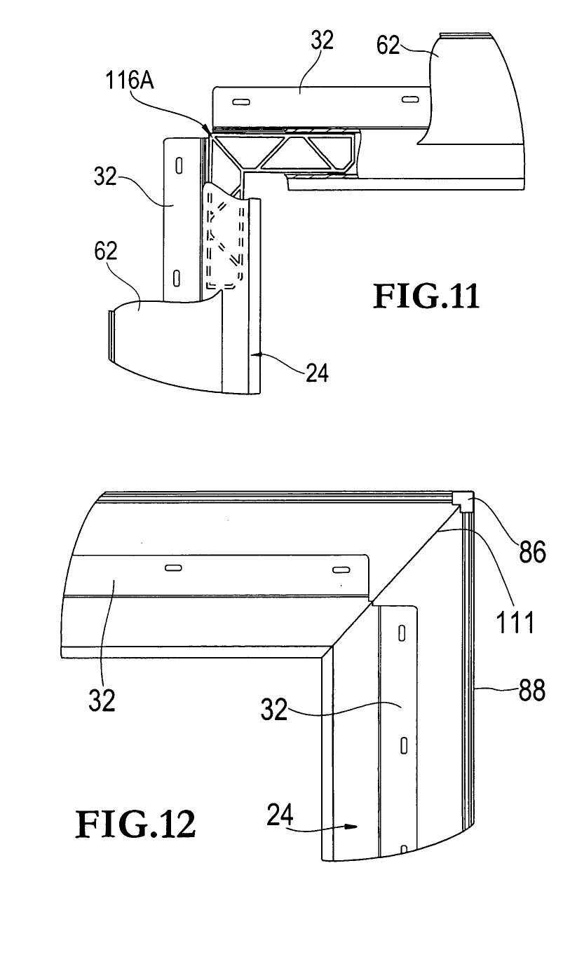

FIG. 10 shows a side elevation view of a corner gusset 116A which is used to join a side jamb assembly 20 to header assembly 22. A such corner gusset is used at each of the corners 111 (FIGS. 11 and 12) at the tops of the respective side jamb assemblies, namely at, for example the miter joints. Gusset 116A includes a pair of legs extending from a common corner. Each leg is defined by an inner panel 118A and an outer panel 120A, and one or more bridging panels 122A which extend as reinforcement members between the inner and outer panels. Each of the inner and outer panels, and the bridging panels, are shown in edge view in FIG. 10. The widths of panels 118A, 120A, 122A extend generally from the outer panel of the extruded/molded aluminum jamb 24 to the inner panel of jamb 24, thus to generally fill the cross-sectional dimensions of tubular cavity 80, at the respective ends of the jamb assemblies.

As illustrated in FIGS. 11 and 12, the respective two legs of gusset 116A are received in the respective tubular cavities of the side jamb and the header jamb at each of the respective corners 111 of the frame, and generally fill the tubular cavities along much of the lengths of the legs. Chamfers at the ends of the respective legs assist in aligning the legs with the tubular cavities as the gussets are installed in the respective cavities. Gussets 116A thus provide location, guidance, and rigidity of the frame, at corners 111.

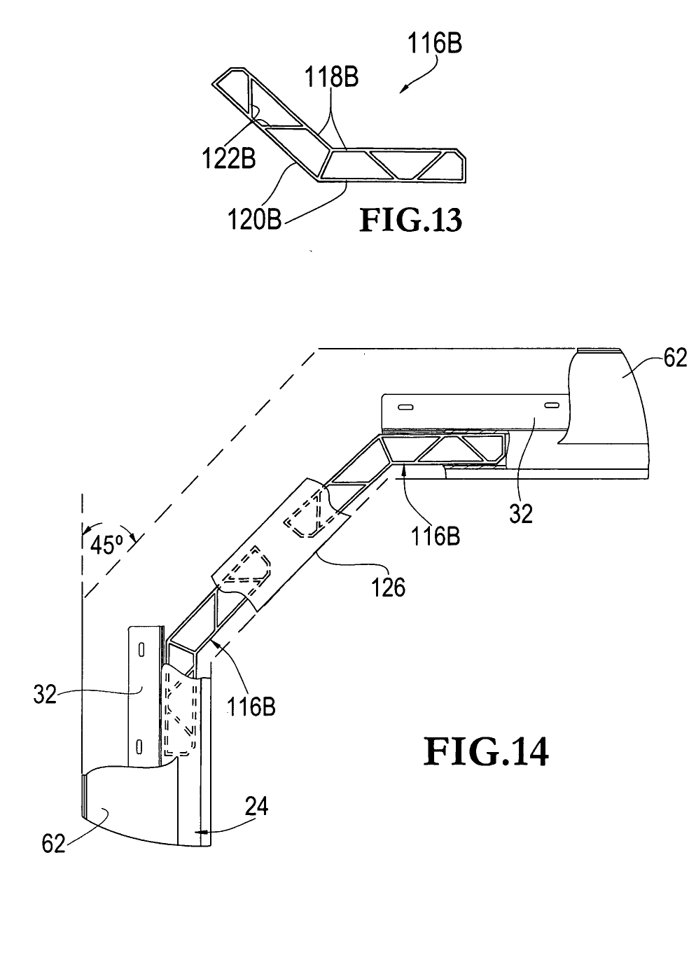

FIG. 13 shows a side elevation view of a second exemplary corner gusset, e.g. corner gusset 116B which is used to join a side jamb assembly 20 to header assembly 22. A such corner gusset is used at each of the corners 111 at the tops of the respective side jamb assemblies and in conjunction with an angled cross-member 126 (FIG. 11), namely at, for example the miter joints. Cross-member 126 has an extruded profile, the same as that of jamb 24.

Gusset 116B includes a pair of legs extending from a common corner. Each leg is defined by an inner panel 118B and an outer panel 120B, and one or more bridging panels 122B which extend as reinforcement members between the inner and outer panels.

Each of the inner and outer panels, and the bridging panels, are shown in edge view in FIG. 13 which shows a side elevation view of corner gussets 116B which are used to join a side jamb to a header jamb, using a gusseted corner of the door frame. The widths of panels 118B, 120B, 122B extend generally from the outer panel of the extruded/molded aluminum jamb 24 to the inner panel of jamb 24, thus to generally fill the cross-sectional dimensions of tubular cavity 80, at the respective ends of the jamb assemblies. As illustrated in FIG. 13, the respective two legs of gusset 116B are received in the respective tubular cavities of the side jamb and the gusset 126 and/or the side jamb and header jamb at each of the respective corners of the frame, and generally fill the tubular cavities along much of the lengths of the legs. Chamfers at the ends of the respective legs assist in aligning the legs with the tubular cavities as the gussets are installed in the respective cavities. Gussets 116B thus provide location, guidance, and rigidity of the frame, at the frame corners similar to gussets 116A.

Also as illustrated in FIG. 13, respective ones of inner panels 118B define an angle of about 135 degrees therebetween. Corner gusset 116B thus forms an e.g. 45 degree angle, relative to what would be the projected 90 degree angle (FIG. 14), at the respective corner and is fabricated using inner and outer panels as in gusset 116A, as well as bridging panels. A pair of gussets shown in the corner assembly of FIG. 14 turns the full 90 degree corner, aided by gusset 126 which is shown in part.

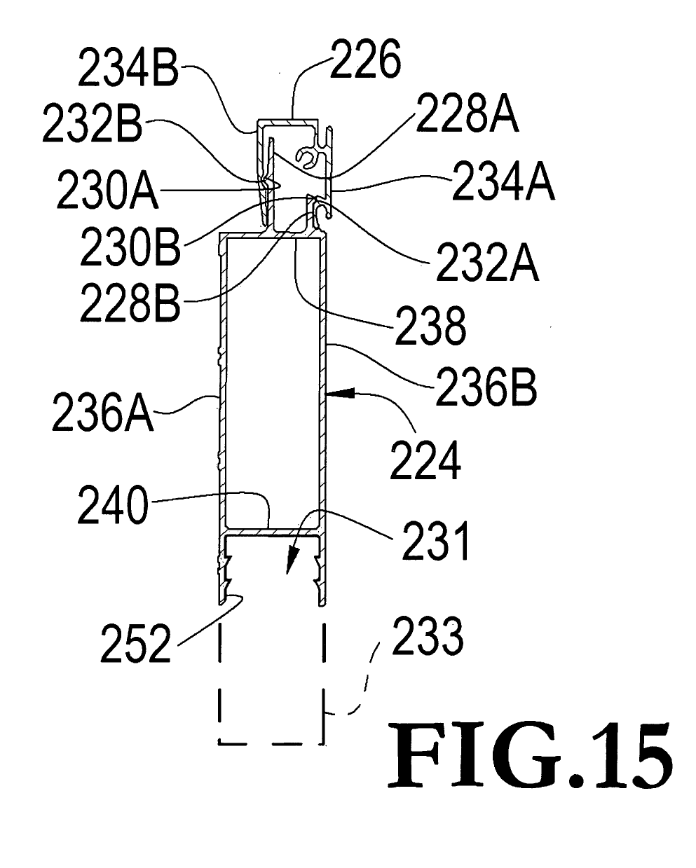

FIG. 15 shows a second embodiment of extruded/molded aluminum jambs 224 of the invention, including a narrow-profile aluminum nosing 226 snap locked to the outer panel of the aluminum jamb extrusion/molding. Mounting structure and/or locking structure, namely legs 228A, 228B, extends outwardly from the outer panel of the jamb extrusion/molding, and snap locks 230A, 230B on legs 228A, 228B and engages corresponding snap locks 232A, 232B on respective legs 234A, 234B of the nosing. Jamb 224 extends from outer panel 238 through side walls 236A, 236B to inner panel 240. Cavity 231 extends from inner panel 240 along cavity side walls 252 to the distal ends of the cavity. Insert 233 is received in cavity 231 much like insert 30 is received in cavity 50.

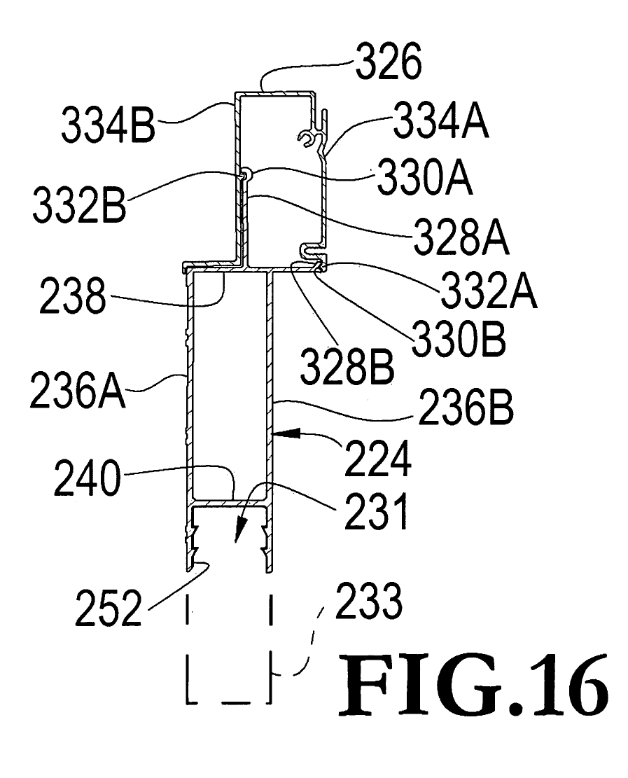

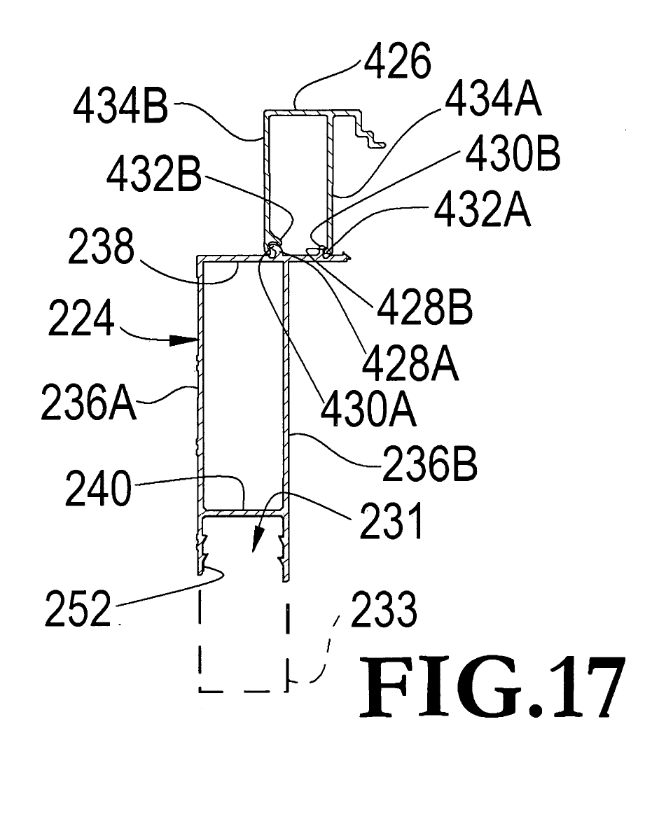

FIG. 16 shows a third embodiment of extruded/molded aluminum jambs of the invention, also including a narrow-profile nosing snap locked to the outer panel of the aluminum jamb extrusion/molding. Namely, the embodiment of FIG. 16 shows yet another embodiment of extruded/molded aluminum jambs of the invention, again including a separate nosing. A durable plastic insert is mounted in a rearwardly open, rearwardly facing cavity in each of the jambs of FIGS. 15 and 16.

As illustrated in FIG. 16, in some exemplary embodiments, mounting structure and/or locking structure, namely legs 328A, 328B, extends outwardly from the outer panel of the jamb extrusion/molding, and snap locks 330A, 330B on legs 328A, 328B and engages corresponding snap locks 332A, 332B on respective legs 334A, 334B of the nosing. Jamb 224 extends from outer panel 238 through side walls 236A, 236B to inner panel 240. Cavity 231 extends from inner panel 240 along cavity side walls 252 to the distal ends of the cavity. Insert 233 is received in cavity 231 much like insert 30 is received in cavity 50.

As in the embodiment of FIG. 15, the exemplary outer panel of the jamb illustrated in FIG. 16 has first and second legs extending toward the outer wall of the nosing, and the nosing has a pair of legs which extend toward, to the outer panel of the jamb. In this embodiment, one of the nosing legs also overlies the otherwise-exposed portion of the outer panel of the jamb. One leg on the outer panel of the jamb is quite short and ends at the nailing fin kerf. The other leg on the jamb is substantially longer. Both legs have snap lock structures at the ends of the legs. One of the legs on the nosing has a snap lock for engaging a leg of the jamb at the end of the nosing leg. The other leg of the nosing has a snap lock structure mid-way of the height of the leg between the outer wall of the nosing and the outer panel of the jamb.

FIG. 17 shows another embodiment of extruded/molded aluminum jambs of the invention, including an aluminum nosing snap locked to the outer panel of the aluminum jamb extrusion/molding as in FIGS. 15 and 16. The nosing includes a reverse-brick-mold casing wing. A rigid aluminum nailing fin is snap locked to the extruded/molded aluminum jamb.

As illustrated in FIG. 17, in some exemplary embodiments, mounting structure and/or locking structure, namely legs 428A, 428B extends outwardly from the outer panel of the jamb extrusion/molding, and snap locks 430A, 430B on legs 428A, 428B and engages corresponding snap locks 432A, 432B on respective legs 434A, 434B of the nosing. Jamb 224 extends from outer panel 238 through side walls 236A, 236B to inner panel 240. Cavity 231 extends from inner panel 240 along cavity side walls 252 to the distal ends of the cavity. Again, insert 233 is received in cavity 231 much like insert 30 is received in cavity 50.

Thus, FIG. 17 shows still another embodiment of extruded/molded aluminum jambs of the invention, yet again including a separate nosing. In this instance, both legs extending from the jamb are quite short, such that the legs extend only far enough to form snap locks, such that the snap locks form substantially the entireties of the legs. Correspondingly, the nosing legs extend substantially the full height of the nosing between the nosing outer wall and the outer panel of the jamb. The nosing incorporates a casing design extending outwardly from the front wall of the nosing in a generally reverse-design brick mold casing panel. A rigid e.g. aluminum nailing fin is mounted to the jamb beyond the side wall of the jamb and beyond the nosing. An insert is received in the cavity as in FIGS. 15 and 16.

In general, the embodiments of FIGS. 15, 16, and 17 have common design with each other, as well as with the embodiments of FIGS. 4 and 6, when considered from, and excluding, the outer panel of the jamb to the back edge of the insert. Accordingly, the embodiments of FIGS. 15, 16, and 17 differ from each other, and from the embodiments of FIGS. 4 and 6, largely at the outer panel, at the nosing, at the nailing fin, and at the casing. The various alternative structures offered with respect to FIGS. 4 and 6 inwardly of the outer panel can as well be applied to the embodiments of FIGS. 15, 16, and 17.

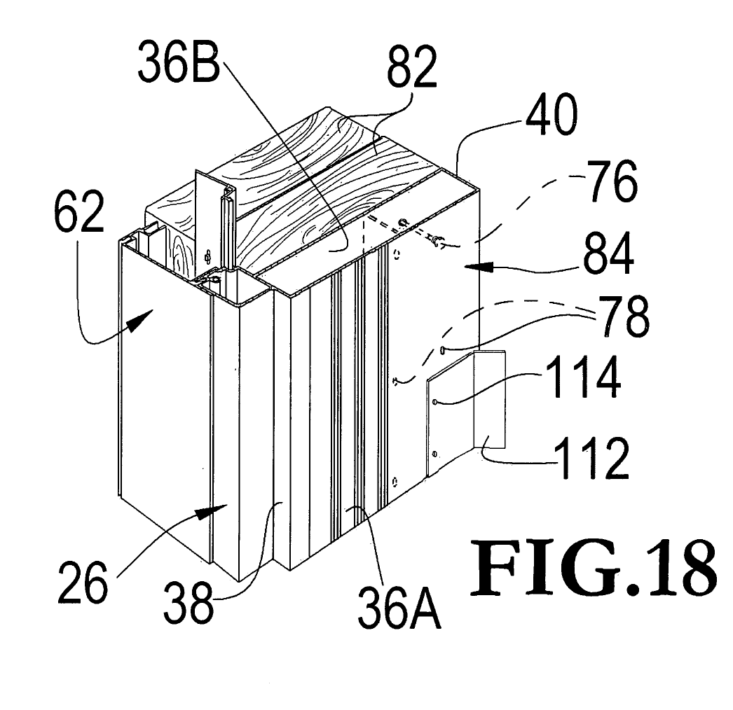

FIG. 18 shows yet another embodiment which omits insert 30, 233. In such embodiment, the width of jamb side panels 36 is relatively lengthened between outer panel 38 and inner panel 40 such that inner panel 40 is moved to the location which had been occupied by the back edge of the insert. As desired, an additional reinforcing web, shown in dashed outline in FIG. 18 can be employed to provide additional side-to-side support in tubular cavity 80. Mounting holes 78 are pre-drilled, pre-formed in side panels 36A, 36B so as to facilitate nailing or screwing the jamb to the framing members of the building. As seen in FIG. 18, in this embodiment, the nosing is formed in common with the jamb such that the nosing and the jamb are integral with each other.

Aluminum extrusion/moldings, including but not limited to jamb 24, nosing 26, brick mold casing 60, extended width casing 62, and other extrusion/moldings, are preferably extrusions wherein the respective profile elements of the extrusions have profile thicknesses “T” of about 0.04 inch to about 0.10 inch, with preferred thicknesses of about 0.06 inch. A highly preferred thickness is about 0.062 inch. Those skilled in the art are well aware of suitable aluminum extrusion processes, e.g. mechanical and/or thermal treatments, and corresponding hardware, e.g. presses, dies, and/or others, to achieve the desired temper, shape, and/or other properties of the extruded aluminum product.

Insert 30, 233 is sized and configured for a tight fit in cavity 50, 231. Insert 30, 233 is installed in the cavity by placing the insert alongside the cavity, in the same orientation as shown in e.g. FIGS. 6 and 15, and is then pushed laterally toward front wall 54. Generally, pressure is applied at a first end of the insert pushing the insert into the cavity at a given location along the length of the insert, namely at the end. With the insert installed at the first end, the force is progressively moved along the length of the insert, progressively forcing the insert into the cavity as the lateral force moves along the length of the cavity. Thus a wheel can be used to apply the force at one end of the insert, whereupon the force can be maintained on the wheel, and the insert and jamb moved progressively past the wheel while the wheel continues to apply the lateral pressure, thus to progressively move the insert into the cavity, along the length of the insert. Thus, in the assemblage of insert 30, 233 and jamb 24, insert 30, 233 is frictionally and/or mechanically housed in cavity 50, 231.

In the alternative, insert 30, 233 can be slidingly inserted into cavity 50, 231, longitudinally along the length of the cavity. Insert 30, 233 and/or cavity 50, 231 can be lubricated with e.g. wet or dry lubricant as necessary or desired.

In some embodiments, side jamb assembly 20 includes a plurality of jamb components in vertical alignment with each other, e.g. “stacked” on top of each other. Namely, side jamb assembly 20 can include an upper member and a lower member. The upper member has a length, and defines at least one cavity which extends along its length. The lower member defines an insert portion received into the cavity and an extension portion which is made of a durable rot and decay resistant material. The extension portion extends downwardly from the lower edge of the upper member a distance sufficient to substantially avoid travel of liquid water, by surface tension, from a lower edge of said lower member to a lower edge of said upper member. Exemplary lengths of extension of the extension portion include at least about two inches, at least about four inches, at least about six inches, at least about ten inches, at least about twenty inches, at least about thirty inches, and others.

To install the door frame, the rough opening must first be “framed into” the building/structure. This is not typically done by the door installer, rather is typically done by the carpenter, and/or other onsite worker, building the building/structure. Namely, the onsite worker installs appropriate header and trimmer studs, such as framing members 82, sufficiently strong and durable to support the span of the rough opening, and the door to be installed therein.

Next, the onsite worker installs the door and/or corresponding door frame. The onsite worker may install the frame as separate components in sequence, e.g. jamb assemblies 20 (which may or may not include nosing 26), header assembly 22, brick mold casing 60 or extended width casing 62, and/or others. In the alternative, the installer may pre-assemble the frame, on site or at a remote location, and “tip” the assembly into the rough opening and subsequently secure it to e.g. the framing members.

Non-metallic materials suitable for components of, and/or attachment structures and accessories, including but not limited to, jamb 24, nosing 26, nailing fin 32, brick mold casing 60, extended width casing 62, and other extrusion/moldings, fins, and related components, are various polymeric compounds. Such polymeric compounds, as for example and without limitation, include various of the polyolefins, such as a variety of the polyethylenes, e.g. high density polyethylene, or polypropylenes. There can also be mentioned as examples such polymers as polyvinyl chloride and chlorinated polyvinyl chloride copolymers, various of the polyamides, polycarbonates, and others.

For any polymeric material employed in structures of the invention, any conventional additive package can be included such as, for example and without limitation, slip agents, anti-block agents, release agents, anti-oxidants, fillers, and plasticizers, to control e.g. processing of the polymeric material as well as to stabilize and/or otherwise control the properties of the finished processed product, also to control hardness, bending resistance, and the like.

Common industry methods of forming such polymeric compounds will suffice to form non-metallic components disclosed herein. Exemplary, but not limiting, of such processes are the various commonly-known plastics converting processes.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A door jamb, having a length, and being adapted to be received into a rough opening in a building, said door jamb comprising an aluminum molding, said aluminum molding comprising:
(a) an aluminum jamb element having a length, and comprising
(i) a first side panel facing toward such rough opening,
(ii) a second side panel facing away from such rough opening,
(iii) an outer panel facing outwardly of such building, and
(iv) an inner panel facing inwardly into such building; and
(b) an aluminum nosing element, integral with said aluminum jamb element and extending outwardly of such building from said outer panel of said jamb element, along a substantial portion of the length of said aluminum jamb element.

2. A door jamb as in claim 1, said nosing having a first side facing toward such rough opening, said first side of said nosing being located away from such rough opening relative to said first side panel of said jamb element.

3. A door jamb as in claim 1, further comprising at least one of (1) a nailing fin kerf, (2) a casing-receiving recess extending along the length of said door jamb, and (3) a cavity in said aluminum jamb element adapted to receive a durable nail-receptive and/or screw-receptive insert along at least a substantial portion of the length of said jamb element.

4. A door jamb as in claim 1, said aluminum molding comprising a cavity adapted to receive an insert thereinto, and further comprising an insert in the cavity, said insert being defined by a durable, rot and decay resistant, material.

5. A door jamb as in claim 4 wherein said insert extends along a substantial portion of the length of said aluminum molding.

6. A door jamb as in claim 4 wherein said insert extends along substantially the full length of said aluminum molding.

7. A door jamb as in claim 4 wherein said insert is made from a material which is receptive to nails and/or screws, as fasteners fastening said insert to a building.

8. A door jamb as in claim 4 wherein a portion of said insert abuts against an edge or surface of said aluminum molding.

9. A door jamb as in claim 1 wherein said aluminum molding extends along substantially the full length of said door jamb.

10. A door jamb as in claim 1, said nosing comprising a mounting fin kerf.

11. A door jamb as in claim 10, further comprising a mounting fin in said mounting fin kerf.

12. A door jamb as in claim 1, said aluminum molding defining a casing-receiving recess extending along the length thereof, further comprising a casing received in the recess.

13. A door jamb as in claim 12, said casing comprising one of (i) a brick mold casing and (ii) a flat casing.

14. A door jamb as in claim 12, said casing comprising a flat casing, an outer surface of said casing, which faces outwardly away from such building, being substantially co-planar with an outer surface of said nosing.

15. A door jamb as in claim 1, said nosing defining a closed cross-section of said nosing.

16. A door frame as in claim 1, said aluminum jamb element defining a closed cross-section of said jamb element.

17. A door jamb as in claim 1, said aluminum jamb element comprising longitudinally spaced mounting holes in said first and second side panels, the mounting holes in said first and second side panels being registered with each other so as to enable fasteners to pass through both of said first and second side panels along straight line paths.

18. A door jamb as in claim 1 wherein said insert is made of hydrophobic material which does not readily absorb a substantial quantity of water, and wherein the hydrophobic material is selected from the group consisting of
(i) polymeric resin, and
(ii) polymeric resin in combination with filler material which is compatible with said polymeric resin, wherein the polymeric resin is sufficiently continuous in the combination to prevent substantial absorption of water into the combination.

19. A door frame as in claim 18 wherein said filler material is selected from the group consisting of wood particles, other cellulosic material, fibrous material, other organic and/or inorganic fillers, and combinations thereof.

20. A door frame as in claim 4, said aluminum jamb element further having a rear defining a closed cross-section of said jamb element, said insert extending, along the length of said jamb element, rearwardly of the rear, whereby said insert can be fastened to such building by driving fasteners through said insert at locations disposed rearwardly of the rear of said jamb element.

21. A door jamb adapted to be received into a rough opening in a building, said door jamb having a length, a rough opening side, and an opposing side, and comprising:
(a) an aluminum molding, said aluminum molding defining an aluminum jamb element having a length, and comprising
(i) a first side panel facing toward such rough opening,
(ii) a second side panel facing away from such rough opening,
(iii) an outer panel facing outwardly of such building,
(iv) a rear opposing said outer panel, and
(v) a cavity extending along the length of said aluminum jamb element, the cavity being adapted to receive an insert thereinto; and
(b) an insert in the cavity, said insert extending along the length of said aluminum jamb element, said insert having a front disposed toward said outer panel and a back disposed relatively toward the rear, said insert being defined by a durable, rot and decay resistant, material which is receptive to nails and/or screws, as fasteners adapted to fasten said insert to such building,
the combination of said aluminum jamb element and said insert providing straight-line paths from the rough opening side of said door jamb to the opposing side of said door jamb, by which nails and/or screws can be driven through said insert without having to create new holes in either the first side panel or the second side panel of said aluminum jamb element, the straight-line paths being located between the back of said insert and a mid-point between said outer panel and said rear of said aluminum molding.

22. A door jamb as in claim 21 wherein the cavity extends along the length of said aluminum jamb element, and wherein the cavity is defined by first and second cavity side panels defined inwardly of the rough opening side of said door jamb and the opposing side of said door jamb, and wherein the cavity is further defined by a front cavity panel disposed between said outer panel and the rear of said aluminum jamb element, an elongate opening extending along a substantial portion of the length of said aluminum jamb element and into the cavity, between the first and second side panels at the rear of said aluminum jamb element.

23. A door jamb as in claim 22 wherein the cavity extends along a substantial portion of said aluminum jamb element.

24. A door jamb as in claim 22 wherein the cavity extends along substantially the full length of said aluminum jamb element.

25. A door jamb as in claim 21, said aluminum jamb element comprising longitudinally spaced mounting holes in said first and second side panels, the mounting holes in said first and second side panels being registered with each other so as to enable fasteners to pass through both of said first and second side panels along straight line paths.

26. A door jamb as in claim 21, said aluminum jamb element defining a closed cross-section of said jamb element, said insert extending, along the length of said jamb element, rearwardly of the rear of said aluminum jamb element, whereby said insert can be fastened to such building by driving fasteners through said insert at locations disposed rearwardly of the rear of said jamb element.

27. A door jamb as in claim 21 wherein the straight-line paths are defined rearwardly of the rear, such that the straight line paths are between the back of said insert and the rear of said aluminum jamb element.

28. A door jamb as in claim 21 wherein the straight-line paths are defined between the rear and the outer panel, and further comprising fastener holes spaced longitudinally along said aluminum jamb element and through said first and second side panels.

29. A door jamb as in claim 21, further comprising locking structure on said aluminum jamb element, extending outwardly of such building from said outer panel and, as a separate element, a nosing mounted to said aluminum jamb element at said outer panel by said locking structure.

30. A door jamb as in claim 21 wherein said insert extends along a substantial portion of the length of said aluminum jamb element.

31. A door jamb as in claim 21 wherein said insert extends along substantially the full length of said aluminum jamb element.

32. A door jamb as in claim 21 wherein a portion of said insert abuts against an edge or surface of said aluminum jamb element.

33. A door jamb as in claim 21 wherein said aluminum jamb element extends along a substantial portion of the length of said door jamb.

34. A door jamb as in claim 21 wherein said aluminum jamb element extends along substantially all of the length of said door jamb.

35. A door jamb as in claim 21, further comprising a nosing extending outwardly from said outer panel and away from such building.

36. A door jamb as in claim 35, said nosing and said jamb element being defined in a common unitary body.

37. A door jamb as in claim 35, said nosing comprising a mounting fin receptacle.

38. A door jamb as in claim 37, further comprising a mounting fin in said mounting fin receptacle.

39. A door jamb as in claim 21, said aluminum jamb element defining a casing-receiving recess extending along the length thereof.

40. A door jamb as in claim 39, further comprising a casing received in the recess.

41. A door jamb as in claim 40, said casing comprising one of (i) a brick mold casing and (ii) a flat casing.

42. A door jamb as in claim 40, further comprising a nosing extending outwardly from said outer panel of said jamb element and away from such building, said casing comprising a flat casing, an outer surface of said casing, which faces outwardly of such building being substantially co-planar with an outer surface of said nosing.

43. A door jamb as in claim 42, said nosing defining a closed cross-section of said nosing.

44. A door jamb as in claim 21, said aluminum jamb element defining a closed cross-section of said jamb member.

45. A door jamb as in claim 21 wherein said durable, rot and decay resistant material comprises hydrophobic material which does not readily absorb a substantial quantity of water, and wherein the hydrophobic material is selected from the group consisting of
(i) polymeric resin, and
(ii) polymeric resin in combination with filler material which is compatible with said polymeric resin, wherein the polymeric resin is sufficiently continuous in the combination to prevent substantial absorption of water into the combination.

46. A door frame adapted to be mounted in a rough opening in a building, said door frame comprising first and second side jamb assemblies, and a header jamb assembly extending between the first and second side jamb assemblies, at least one said side jamb assembly having an upper member and a lower member, the upper member having a length, and defining at least one cavity extending along the length thereof, the lower member defining an insert portion received into the cavity and an extension portion extending downwardly from the lower edge of the upper member a distance sufficient to substantially avoid travel of liquid water, by surface tension, from a lower edge of said lower member to a lower edge of said upper member, the extension portion being defined by a durable rot and decay resistant material.

47. A door frame as in claim 46 wherein the insert portion extends along a substantial portion of the length of said upper member.

48. A door frame as in claim 46 wherein the insert portion extends along substantially the full length of said upper member.

49. A door frame as in claim 48 wherein the insert portion is made from a material which is receptive to nails and/or screws, as fasteners fastening the insert portion to such building.

50. A door frame as in claim 46 wherein a portion of the lower member abuts against an edge or surface of the upper member of said jamb assembly.

51. A door frame as in claim 46 wherein said upper member comprises an aluminum molding extending along a substantial portion of the length of said side jamb assembly.

52. A door frame as in claim 46 wherein said upper member comprises an aluminum molding extending along substantially all of the length of said side jamb assembly.

53. A door frame as in claim 46, said upper member comprising a jamb member having an outer panel adapted to face away from such building, said upper member further comprising a nosing extending outwardly, away from such building from said outer panel, said nosing and said jamb member being defined in a common unitary body.

54. A door frame as in claim 53, said nosing comprising a mounting fin kerf.

55. A door frame as in claim 54, further comprising a mounting fin in said mounting fin kerf.

56. A door frame as in claim 53, said upper member defining a casing-receiving recess extending along the length thereof.

57. A door frame as in claim 56, further comprising a casing received in the recess.

58. A door frame as in claim 57, said casing comprising one of (i) a brick mold casing and (ii) a flat casing.

59. A door frame as in claim 57, said casing comprising a flat casing, an outer surface of said casing, which faces outwardly away from such building, being substantially co-planar with an outer surface of said nosing.

60. A door frame as in claim 53, said nosing defining a closed cross-section of said nosing.

61. A door frame as in claim 53, said jamb member defining a closed cross-section of said jamb member.

62. A door frame as in claim 46, said upper member comprising a jamb member having a first side panel facing into such rough opening in such building, and a second opposing side panel facing away from such rough opening, further comprising spaced mounting holes in said first and second side panels, the mounting holes in said first and second side panels being registered with each other so as to enable fasteners to pass through both of said first and second side panels along straight line paths.

63. A door frame as in claim 46, said header jamb assembly having opposing ends which define first and second miter joints with said first and second side jamb assemblies, further comprising spring clips which extend across the first and second miter joints, and which engage locking elements in said upper members and in said header assembly, thereby to control movement of a respective said end of said header jamb assembly and the corresponding side jamb assembly with respect to each other, in a direction toward and/or away from such building.

64. A door frame as in claim 46 wherein the extension portion of said lower member is made of hydrophobic material which does not readily absorb a substantial quantity of water, and wherein the hydrophobic material is selected from the group consisting of
(i) polymeric resin, and
(ii) polymeric resin in combination with filler material which is compatible with said polymeric resin, wherein the polymeric resin is sufficiently continuous in the combination to prevent substantial absorption of water into the combination.

65. A door frame as in claim 64 wherein said filler material is selected from the group consisting of wood particles, other cellulosic material, fibrous material, other organic and/or inorganic fillers, and combinations thereof.

66. A door frame as in claim 46, said upper member having a rear defining a closed cross-section of said upper member, said insert portion of said lower member extending, along the length of said upper member, and rearwardly of a rear of said upper member, whereby said insert portion can be fastened to such building by driving fasteners through said insert portion at locations disposed rearwardly of the rear of said upper member.

67. A door frame adapted to be mounted in a rough opening in a building, said door frame comprising:
(a) first and second side jamb assemblies, at least one of said side jamb assemblies comprising an aluminum jamb element having a length, and comprising
(i) a first side panel facing toward such rough opening,
(ii) a second side panel facing away from such rough opening,
(iii) an outer panel facing outwardly of such building, and
(iv) an inner panel facing inwardly into such building at or proximate a rear of said aluminum jamb element,
said aluminum jamb element extending substantially the entirety of the length of said jamb assembly such that said at least one side jamb assembly is supported, by said aluminum extrusion, from an underlying support, within a distance of such underlying support to enable travel of liquid water, by surface tension, from a lower edge of said side jamb assembly to said aluminum jamb element; and
(b) a header extending between the first and second side jamb assemblies.

68. A door frame as in claim 67, further comprising a nosing extending outwardly from said outer panel and away from such building.

69. A door frame as in claim 67, said at least one side jamb assembly further comprising a cavity extending along the length of said aluminum jamb element, the cavity being adapted to receive an insert thereinto.

70. A door frame as in claim 69, further comprising an insert in the cavity, said insert extending along the length of said aluminum jamb element, said insert having a front disposed toward said outer panel and a back disposed relatively toward the rear of said jamb element, said insert being defined by a durable, rot and decay resistant, material which is receptive to nails and/or screws, as fasteners adapted to fasten said insert to such building.

71. A door frame as in claim 70 wherein the cavity extends along the length of said aluminum jamb element, and wherein the cavity is defined at least in part by the first and second side panels and said inner panel, an elongate opening extending along a substantial portion of the length of said aluminum jamb element and into the cavity, between the first and second side panels at the rear of said aluminum jamb element.

72. A door frame as in claim 71 wherein the cavity extends along a substantial portion of the length of said aluminum jamb element.

73. A door frame as in claim 71 wherein the cavity extends along substantially the full length of said aluminum jamb element.

74. A door frame as in claim 67 said aluminum jamb element comprising longitudinally spaced mounting holes in said first and second side panels, the mounting holes in said first and second side panels being registered with each other so as to enable fasteners to pass through both of said first and second side panels along straight line paths.

75. A door frame as in claim 70, said aluminum jamb element defining a closed cross-section of said jamb element, said insert extending, along the length of said jamb element, rearwardly of the rear, whereby said insert can be fastened to such building by driving fasteners through said insert at locations disposed rearwardly of the rear of said jamb element.

76. A door frame as in claim 67, further comprising locking structure on said jamb element, extending outwardly of such building from said outer panel and, as a separate element, a nosing mounted to said aluminum jamb element at said outer panel by said locking structure.

77. A door frame as in claim 70 wherein said insert extends along a substantial portion of the length of said aluminum jamb element.

78. A door frame as in claim 70 wherein said insert extends along substantially the full length of said aluminum jamb element.

79. A door frame as in claim 70 wherein a portion of said insert abuts against an exterior edge or surface of said aluminum jamb element.

80. A door frame as in claim 67 wherein said aluminum jamb element extends along a substantial portion of the length of said door jamb.

81. A door frame as in claim 67 wherein said aluminum jamb element extends along substantially all of the length of said door jamb.

82. A door frame as in claim 68, said nosing comprising a mounting fin receptacle.

83. A door frame as in claim 82, further comprising a mounting fin in said mounting fin receptacle.

84. A door frame as in claim 67, said aluminum jamb element defining a casing-receiving recess extending along the length thereof.

85. A door frame as in claim 67, further comprising a casing received in the recess.

86. A door frame as in claim 67, further comprising a nosing extending outwardly from said outer panel of said jamb element and away from such building, said casing comprising a flat casing, an outer surface of said casing, which faces outwardly of such building being substantially co-planar with an outer surface of said nosing.

87. A door frame as in claim 70 wherein said durable, rot and decay resistant material comprises hydrophobic material which does not readily absorb a substantial quantity of water, and wherein the hydrophobic material is selected from the group consisting of
(i) polymeric resin, and
(ii) polymeric resin in combination with filler material which is compatible with said polymeric resin, wherein the polymeric resin is sufficiently continuous in the combination to prevent substantial absorption of water into the combination.
